(19) United States
(12) Patent Application Publication
(10) Pub. No.: US 2019/0093188 A1
(43) Pub. Date: Mar. 28, 2019

(54) CRYOGENIC CHAMBER SYSTEMS AND METHODS

(71) Applicant: Stan Chandler, South Jordan, UT (US)

(72) Inventor: Stan Chandler, South Jordan, UT (US)

(21) Appl. No.: 16/143,779

(22) Filed: Sep. 27, 2018

Related U.S. Application Data
(60) Provisional application No. 62/563,864, filed on Sep. 27, 2017.

(51) Int. Cl. C21D 1/613; F25D 3/10; F25D 29/00

(52) U.S. Cl. CPC C21D 1/613; G01N 1/42; F25D 29/001; F25D 3/10

(57) ABSTRACT

A cryogenic chamber system can include a vacuum chamber operable at a vacuum pressure of 100 mTorr or less, and a cold head assembly including an expander for receiving and expanding cryogenic fluid for cooling a cold head interface. The cold head assembly can be positioned within the vacuum chamber. The cryogenic chamber system can further include a thermally conductive platform thermally coupled to the cold head interface within the vacuum chamber, wherein the thermally conductive platform has a working surface having a surface area that is at least 10 times larger than a surface area of the cold head interface. The working surface can be configured to reach a temperature from about 4 K to about 120 K at the vacuum pressure as a result of thermal coupling with the cold head interface.

### BACKGROUND

Cryogenic hardening of materials, such as various types of metal objects, can provide various benefits to the object being treated. For example, a cryogenically treated metal can exhibit enhanced durability compared to an untreated steel. Though not all metal objects benefit from cryogenic treatment, it can be effective in enhancing heat-treated martensitic steels, such as high carbon and high chromium steels, as well as steels commonly used in metal machine parts and tools. In addition to steels, cryogenic hardening can also be beneficial for treating cast iron, copper alloys, aluminum, magnesium, and tungsten, to name a few. For example, the process can improve the wear life of these types of metal parts by factors of two to six in some cases.

With respect to heat treated steels in particular, retained austenite that may be present can be transformed into harder martensite steel, thus resulting in fewer imperfections and grain structure weakness. Furthermore, cryogenic hardening can also provide enhanced wear resistance and corrosion resistance to certain metal objects by increasing the precipitation of eta-carbides, which are fine carbides that provide binding support to the martensite structural matrix. Still further, inherent stresses that may exist in a metal object that can be generated when liquid metal solidifies can be relieved by cryogenic hardening processes. In other words, metal stresses that can result in weak areas of a metal object can be reduced by reorienting the grain structure to exhibit a more uniform grain structure to some degree, thereby reducing the probability of potential metal object or part failure at those stressed locations.

Most typically, the process of cryogenically treating or hardening a metal object can include submersing the metal object in liquid nitrogen. To avoid introducing additional thermal stresses to the metal object, the metal object can be cooled slowly and then dipped in liquid nitrogen at a cryogenic temperature, e.g., temperatures below −150° C. (about 123 K). For example, the metal object can be slowly cooled and then dipped in liquid nitrogen at a temperature of around −190° C. for 20 to 24 hours and then the metal object can be heat tempered at temperatures above about 149° C. Heat tempering can help reduce brittleness that may have been introduced by formation of the martensite in the case of steel. Other example cryogenic temperatures and heat tempering temperatures can alternatively be used, depending on the cryogenic medium, the metal object material, the desired hardness, equipment limitations, and/or other possible factors.

With specific reference to cryogenic treatment using liquid nitrogen, there are limitations regarding the lower end of the cryogenic temperature that may be achieved. For example, metal objects can be submersed in liquid nitrogen at temperatures as low as about −196° C. (77 K), which is the boiling point of liquid nitrogen. Furthermore, under vacuum, liquid nitrogen is brought to its freezing point, which is about −210° C. (63 K). Thus, though liquid nitrogen provides an acceptable medium for cryogenic hardening of many metals, there is a practical limitation on the low end of the cryogenic temperature range, e.g., −196° C. (77K) at standard sea level pressure.

### BRIEF DESCRIPTION OF THE DRAWINGS

FIG. 1 is a schematic, partial cross-sectional view of an example cryogenic chamber system fluidly and electrically coupled to a compressor in accordance with the present disclosure;

FIG. 2 is a schematic, partial cross-sectional view of an example cryogenic chamber system and associated fluid flow paths in accordance with the present disclosure;

FIG. 3 is a schematic, partial cross-sectional view of an alternative example cryogenic chamber system with a dual stage cold head assembly in accordance with the present disclosure;

FIG. 4 is a schematic top view depicting various example arrangements and size relationships of cold head interfaces, thermally conductive platforms, vacuum chamber walls, and object openings; and

FIG. 5 is a flow chart depicting example methods of cryogenically treating metal objects in accordance with the present disclosure.

### DETAILED DESCRIPTION

In accordance with the present disclosure, cryogenic chamber systems and methods of cryogenically treating metal objects are disclosed. In one example, a cryogenic chamber system can include a vacuum chamber operable at a vacuum pressure of 100 mTorr or less, and a cold head assembly including an expander assembly for receiving and expanding cryogenic fluid for cooling a cold head interface. The cold head assembly can be positioned within the vacuum chamber. The cryogenic chamber system can also include a thermally conductive platform thermally coupled to the cold head interface within the vacuum chamber. The thermally conductive platform can have a working surface with a surface area that is at least 10 times larger than a surface area of the cold head interface. Furthermore, the working surface can be configured to reach a temperature from about 4 K to about 120 K at the vacuum pressure as a result of thermal coupling with the cold head interface.

In another example, a cryogenic chamber system can include a vacuum chamber operable at a vacuum pressure of 100 mTorr or less, and a cold head assembly including an expander assembly for receiving and expanding cryogenic fluid for cooling a cold head interface. The cold head assembly can be positioned within the vacuum chamber. In further detail, a thermally conductive platform can be thermally coupled to the cold head interface within the vacuum chamber. In this example, the cryogenic chamber system can be configured so that no other thermally conductive structure that would introduce heat to the thermally conductive platform when the cryogenic chamber system is in operation is in contact therewith. In further detail, the cryogenic chamber system can include insulative standoffs positioned to support the thermally conductive platform without introducing heat to the thermally conductive platform.

In another example, a method of cryogenically treating metal objects can include placing a metal object in thermal contact with a working surface of a thermally conductive platform such that the thermally conductive platform is in thermal contact with a cold head interface of a cold head assembly. The method can also include generating a vacuum pressure of 100 mTorr or less around the metal object, the thermally conductive platform, and the cold head assembly. An additional step can include reducing a temperature of the cold head interface to cause the working surface to reach a working temperature from about 4 K to about 120 K, wherein the metal object is brought to an object temperature from about 4 K to about 120 K. The method can also include maintaining the metal object at the object temperature until the metal object has at least partially cryogenically hardened, e.g., about 15 minutes to about 36 hours, about 30 minutes to about 18 hours, about 1 hour to about 10 hours, about 1 hour to about 6 hours, etc. In one example, at the vacuum pressure and working temperature, substantially no liquid condensation forms on the metal object without the presence of any condensation control elements. In another example, the entire working surface can be brought to within 50% of a temperature K of the cold head interface or even within 25% of a temperature K of the cold head interface, such as when the working surface is at least 10 times larger, at least 20 times larger, at least 40 times larger, or at least 60 times larger than a surface area of the cold head interface.

There are additional details that can be implemented in some examples of the present disclosure that relate to the cryogenic chamber systems described above and hereinafter, as well as the method of cryogenically treating metal objects described above and hereinafter. For example, even with the considerably larger working surface area compared to the surface area of the cold head interface, the temperature can be reached along the entire working surface. In another example, a vacuum pump can be fluidly coupled to the vacuum chamber and configured to generate vacuum pressure from about 5 mTorr to about 25 mTorr within the vacuum chamber. The vacuum chamber can include two chambers coupled together with a coupling seal, for example. The two chambers can include an insulative chamber about the cold head assembly and a cryogenic treatment chamber which contains the thermally conductive platform, and the cold head interface can be at least partially within one or both of the insulative chamber or the cryogenic treatment chamber. The expander assembly can include, for example, one or more linearly actuated displacer. In further detail, the expander can be a single stage expander assembly or a dual stage expander assembly. The cryogenic fluid is helium-3, helium-4, hydrogen, neon, nitrogen, air, fluorine, argon, oxygen, methane, or a mixture thereof. The working surface can be configured to reach one or more temperature from about 4 K to about 50 K at the vacuum pressure, or one or more temperature from about 10 K to less than the boiling point of nitrogen at the vacuum pressure, or one or more temperature from about 10 K to about 25 K at about 10 mTorr to about 25 mTorr of vacuum pressure, for example. The thermally conductive platform may also include a connecting surface, and the cold head interface can be thermally coupled to the connecting surface, such as by a flanged collar that is both attached to the cold head assembly and the connecting surface. In one example, the system may be set up so that no thermally conductive structure that would introduce heat to the thermally conductive platform is in contact therewith. To accomplish this, in one example, the thermally conductive platform may be further supported by insulative standoffs, e.g., ceramic standoffs which may be positioned between the thermally conductive platform and a cryogenic chamber wall (floor beneath, sidewall, etc.) of the vacuum chamber. Thus, in some examples, the thermally conductive platform is only in thermal contact with the cold head interface and a coupling assembly used to couple the thermally conductive platform to the connecting surface, and wherein neither the thermally conductive platform nor the coupling assembly are in contact with a cryogenic chamber wall of the vacuum chamber. The cold head interface can be thermally coupled to the connecting surface at a central region of the thermally conductive platform, and the thermally conductive platform can be of a material and configuration that a periphery of the entire working surface is brought to within 50% of a temperature K of the cold head interface, e.g., cold head at about 10 K with all points of working surface at from about 10 K to about 15 K. In certain examples, the cold head interface can have a surface area from about 3 in² to about 120 in², from about 6 in² to about 80 in², from about 12 in² to about 50 in², from about 25 in² to about 120 in², from about 1.5 ft² to about 100 ft², from about 2.25 ft² to about 60 ft², or from about 4 ft² to about 40 ft². The vacuum chamber can include an object opening for inserting metal objects on the working surface of the thermally conductive platform, e.g., object opening is at least 80% in area size as the surface area of the working surface, or the object opening is about as large or larger in area size as the surface area of the working surface. The system can further include a lid adapted to seal against the object opening. The lid can include at least a portion that is transparent or sufficiently translucent to view metal objects positioned on the working surface. The working surface can have a surface area that is at least 10 times larger than a surface area of the cold head interface, at least 20 times larger than a surface area of the cold head interface, at least 40 times larger than a surface area of the cold head interface, or at least 60 times larger than a surface area of the cold head interface. The thermally conductive platform can have an average thickness from about ⅛ inch to about 2 inches, or from about ¼ inch to about 1 inch. In certain examples, the thermally conductive platform can have a thickness and span that would otherwise bend or bow. Even so, such a platform can still be supported by the insulative standoffs to prevent the thermally conductive platform from contacting a cryogenic chamber wall of the vacuum chamber. In some examples, the vacuum chamber does not further include any condensation control elements therein. In other examples, the thermally conductive platform has a plate-like configuration, a box-like configuration, a curved configuration, or a specialized shape configuration to match a feature of a predetermined metal object.

With these examples and details in mind, it is noted that when discussing cryogenic chamber systems or methods of cryogenically treating metal objects, each of these discussions can be considered applicable to the other embodiment whether or not that feature is explicitly discussed in the context of the other example. To illustrate, in discussing a cold head assembly in the context of one or more cryogenic chamber systems, that same discussion regarding the cold head assembly is also relevant and directly supportive of the methods of cryogenically treating metal objects, and vice versa.

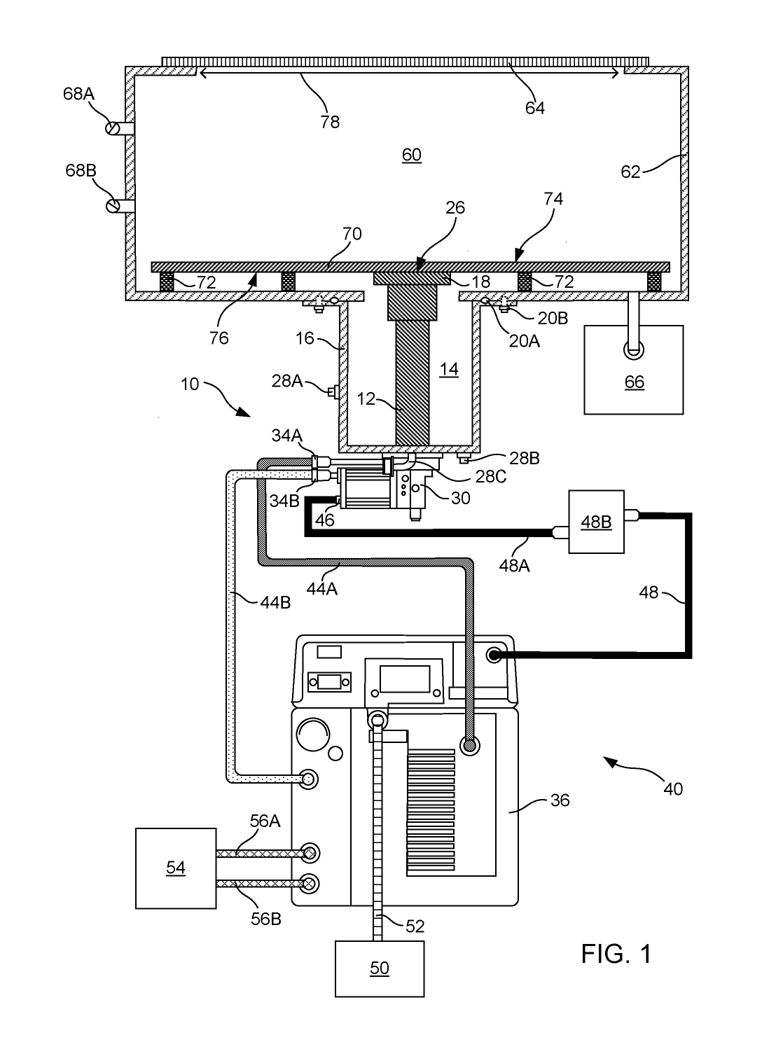

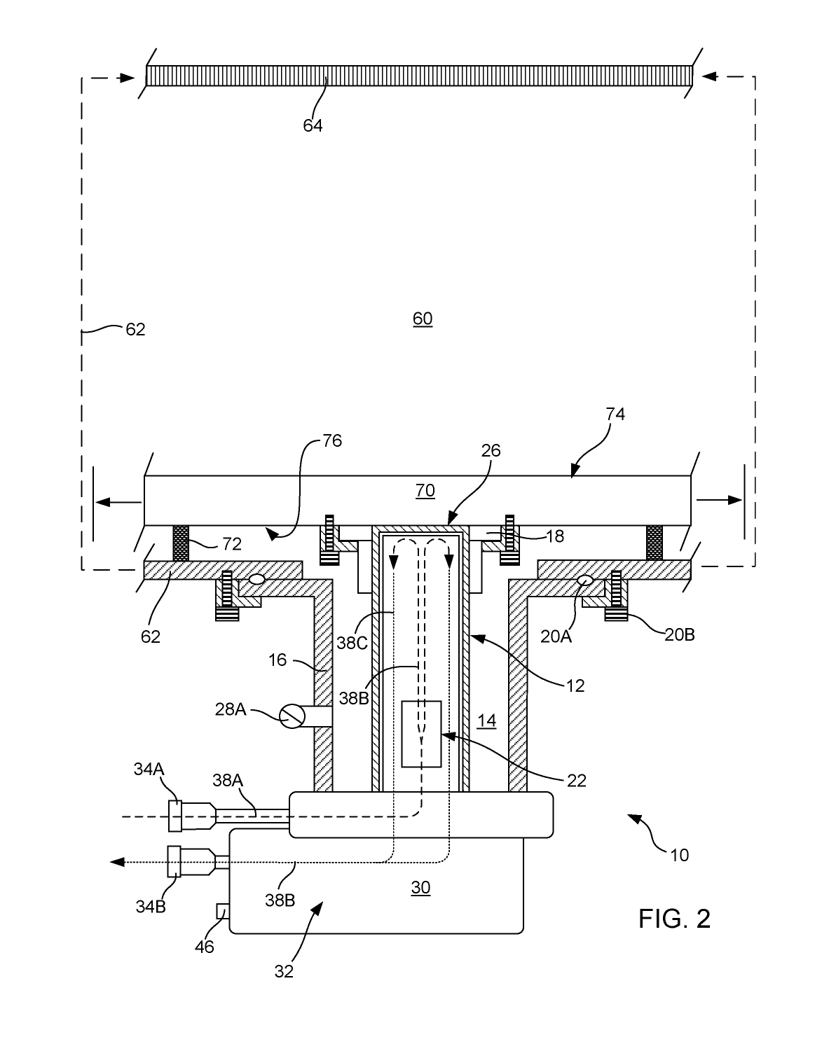

Turning now to the FIGS., FIGS. 1-3 for more specific example embodiments, these FIGS. depict different levels of detail of cryogenic chamber systems in accordance with the present disclosure. FIGS. 1 and 2 will be described simultaneously, as each provides a different level of detail regarding the cryogenic chamber systems of the present disclosure. In particular, these FIGS. show example cryogenic chamber systems including a cryogenic pump 10 fluidly and electrically coupled to a compressor system 40 in accordance with the present disclosure. In further detail, the cryogenic chamber system can include a vacuum pump 66 fluidly coupled to the vacuum chamber 14, 60. In one example, the vacuum pump can be a rotary vane pump, such as Leybold Heraeus D-4 pump, but any other similar type of vacuum pump suitable to bring the vacuum pressure to less than or equal to 100 mTorr (with a practical lower limit based on equipment of about 3 to about 5 mTorr) can be used. In one example, the vacuum pump can be configured to generate vacuum pressure at from about 5 mTorr to about 25 mTorr within the vacuum chamber. In another example, the vacuum pressure can be from about 8 mTorr to about 15 mTorr. In further detail, the vacuum chamber can actually be an assembly of two different chambers coupled together with a coupling assembly, which in this example includes a coupling seal 20A and a threaded fastener 20B. Thus, the two different chambers, namely the insulative chamber 14 defined by a cryogenic pump vessel wall 16, and a cryogenic treatment chamber 60 defined by a cryogenic chamber wall 62, can be joined together by the coupling assembly. When joined and sealed, the two respective chambers form a fluidly coupled single vacuum chamber, where the insulative chamber primarily houses and insulates, e.g., with open air space, a cold head assembly 12, and the cryogenic treatment chamber houses a thermally conductive platform 70 and any metal object placed thereon (not shown) for cryogenic treatment. The cryogenic pump vessel wall and/or the cryogenic chamber wall can be of any rigid material that can handle vacuum pressures less than 100 mTorr without substantial deformation. Suitable materials that can be used include Plexiglas®, aluminum, stainless steel, titanium, copper, or another solid metal or metal alloy material. Depending on the material, various thicknesses can be used to provide the desired rigidness to accommodate operational vacuum pressures. Furthermore, in this example, a lid 64 can be placed on an object opening 78 to seal the chamber for receiving negative vacuum pressure from the vacuum pump. In one example, the lid can be adapted so that at least a portion is transparent or sufficiently translucent to view metal objects positioned on the working surface. The lid can include Plexiglas®, aluminum, stainless steel, or other rigid material suitable for withstanding the vacuum pressure along the area of the object opening. In one example, the lid can be flat, as shown, or can be box-shaped with its rim sealing against a rim of the cryogenic chamber walls. The lid can likewise be hinged, or can simply be placed on the object opening with the vacuum pressure holding the lid in place. In further detail, a lid seal or gasket can be used to seal the lid to a periphery around the object opening, for example.

The vacuum pump 66 in this example is shown fluidly coupled to the cryogenic treatment chamber 60 through an opening in the cryogenic chamber wall 62, but could alternatively be coupled elsewhere to the cryogenic treatment chamber and/or to the insulative chamber 14 through the cryogenic pump vessel wall 16, such as through any of the auxiliary ports or valves shown at 28A, 28B, 28C, 68A, or 68B. These various ports or valves can be used for this or any other suitable purpose for monitoring and/or controlling the cryogenic chamber system, such as for receiving a roughing vacuum pump, a vent valve, a surge relief valve, a pressure relief valve, a temperature sensor, etc.

In one example, the cold head interface 26 (of the cold head assembly 12) can be at least partially within one or both of the insulative chamber 14 or the cryogenic treatment chamber 60, depending on the specific configuration of the two chambers and/or the configuration of the cold head assembly. In this example, the cold head interface extends out of the insulative chamber and into the cryogenic treatment chamber, where it can be thermally coupled to the thermally conductive platform 70. In this example, the cold head assembly includes a coupling assembly 18, which can include a flanged collar and coupling hardware (not shown, but which can be similar to that shown at 20B), for example, which can be used to connect the cold head assembly with the thermally conductive platform. When connected together, the cold head interface can be in thermal contact or communication with the thermally conductive platform, thus providing a mechanism for thermal transfer from the cold head interface to the thermally conductive platform.

In further detail regarding the operation of the cryogenic pump 10, which in this example includes the cold head assembly 12 and a motor shown generally at 32 within motor housing 30, for operating an expander assembly 22, the motor can operate a displacer with the expansion assembly, such as a reciprocating piston-type displacer (not shown), which cyclically receives and expands the cryogenic fluid to cool the cold head assembly, and more specifically, the cold head interface 26. In one example, the motor can drive a crosshead assembly that converts the rotary motion of the motor to reciprocating motion that may be present to drive the displacer of the expander assembly. The expander assembly can be present anywhere along the cold head assembly and/or within the housing, provided the conditions at the location of cryogenic fluid expansion are suitable for expanding and cooling the cryogenic fluid. More specifically, pressurized cryogenic fluid 38A, such as helium, as pressurized using compressor 36, can be channeled through a cryogenic fluid supply line 44A to cryogenic fluid supply port 34A, where the pressurized cryogenic fluid is channeled to the expander assembly, or multiple expander assemblies, for rapid cooling. This cooling process generates expanded cryogenic fluid 38B, which is what provides the cryogenic temperatures to the cold head assembly, and ultimately to the cold head interface. After cooling the cold head assembly and cold head interface, warmed cryogenic fluid 38C is generated by heat exchange, such as in a displacer, where the warmed cryogenic fluid is returned to the compressor via the cryogenic fluid return port 34B and cryogenic fluid return line 44B. Thus, the warmed cryogenic fluid returning from the cryogenic pump can re-enter the compressor, and in some examples, a small quantity of oil can be injected into the gas stream to overcome the low specific heat that may be a property of certain cryogenic fluids, e.g., helium may not be capable of carrying heat produced during compression. Thus, within the compressor in some examples, the helium can be further processed by injecting and/or misting oil at various stages, filtering to remove oil and contaminants, modulating pressure, etc., in order to prepare the cryogenic fluid for further use as it is again recycled through the cryogenic pump. Processing and operation apparatuses, such as a water cooler 54 with a cooling water supply line 56A and a water return line 56B, and a power supply 50 connected through a power supply line 52, can be present to provide suitable power requirements to the compressor, e.g., 208 VAC, 220 VAC, 230 VAC, or 240 VAC. The cryogenic pump can be powered, in one example, by the compressor as its power source, though that is not necessarily always the case. In this example, a power cable 48A electrically connects the compressor to the cryogenic pump via power connection port 46. Furthermore, with certain cryogenic pumps and/or certain cryogenic pump configurations, an electrical interface controller 48B can be present to further assist with controlling the system as a whole. Thus, the power cable can act to provide power to a cryogenic pump motor, and can also act as a controller, coordinating operational parameters between the compressor system 40 and the cryogenic pump.

The cryogenic pump 10 can be configured to generate temperatures from about 4 K to about 120 K, for example (with helium). In one specific example, even when the cryogenic pump is a single stage system, such as that shown at 22 in FIGS. 1 and 2, temperatures as low as about 10 K (with helium) can be reached by modulating the cryogenic fluid content in the cold head assembly 12. Notably, with other cryogenic fluids or gases, the lower end of the temperature range can be modified upward according to the respective boiling point of the cryogenic fluid being used. The boiling points of various cryogenic fluids can provide information regarding these range modifications that can be determined in accordance with examples of the present disclosure. For example, the lower end of the achievable temperature range (at the cold head interface 26) can typically be at or about the temperatures shown in Table 1.

TABLE 1

| Cryogenic Fluid | Boiling Point (K) |
|---|---|
| Helium-3 | 3.19 |
| Helium-4 | 4.214 |
| Hydrogen | 20.27 |
| Neon | 27.09 |
| Nitrogen | 77.36 |
| Air | 78.8 |
| Fluorine | 85.24 |
| Argon | 87.24 |
| Oxygen | 90.18 |
| Methane | 111.7 |

Thus, with the upper end of the range at about 120 K, appropriate ranges can be as follows: helium generally can reach temperatures ranging from about 4 K to about 120 K, hydrogen can be from about 20 K to about 120 K, neon can be from about 27 K to about 120 K, nitrogen can be from about 77 K to about 120 K, air can be from about 79 K to about 120 K, fluorine can be from about 85 K to about 120 K, argon can be from about 87 K to about 120 K, oxygen can be from about 90 K to about 120 K, or methane can be from about 112 K to about 120 K (each rounded to the nearest 1 K), In particular, the lower end of the ranges may be more appropriately achieved using a dual stage system, but in some examples, may be able to be achieved using a single stage system with modified system parameters, e.g., enhanced volumes of cryogenic fluid, additional time to reach lower temperatures, etc. As an example, in a dual stage system helium cryogenic fluid may be brought to temperatures as low as about 4 K, whereas with a single stage system, reaching temperatures as low as about 10 K can occur with appropriate volumes of helium and cooling time. In further detail, in a single stage system, methane may not be able to be cooled to below about 120 K, but the other cryogenic fluids in Table 1 may all be able to reach temperatures below 120 K under appropriate system parameters. Thus, taking into account the cryogenic fluid selected for use, as this type of equipment can be thermostatically controlled to a preselected temperature profile within a very low range of temperatures, e.g., from about 4 K to about 120 K or more for helium, unlike liquid nitrogen treatments, there can be some degree of temperature and time programmability. For example, predetermined or desired temperature and/or time profiles can be programmed for a specific type of metal object to be cryogenically treated, e.g., from about 4 K to about 120 K, from about 10 K to less than about 77 K, etc., for a time ranging from about 15 minutes to about 36 hours, about 30 minutes to about 18 hours, about 1 hour to about 10 hours, about 1 hour to about 6 hours, etc.

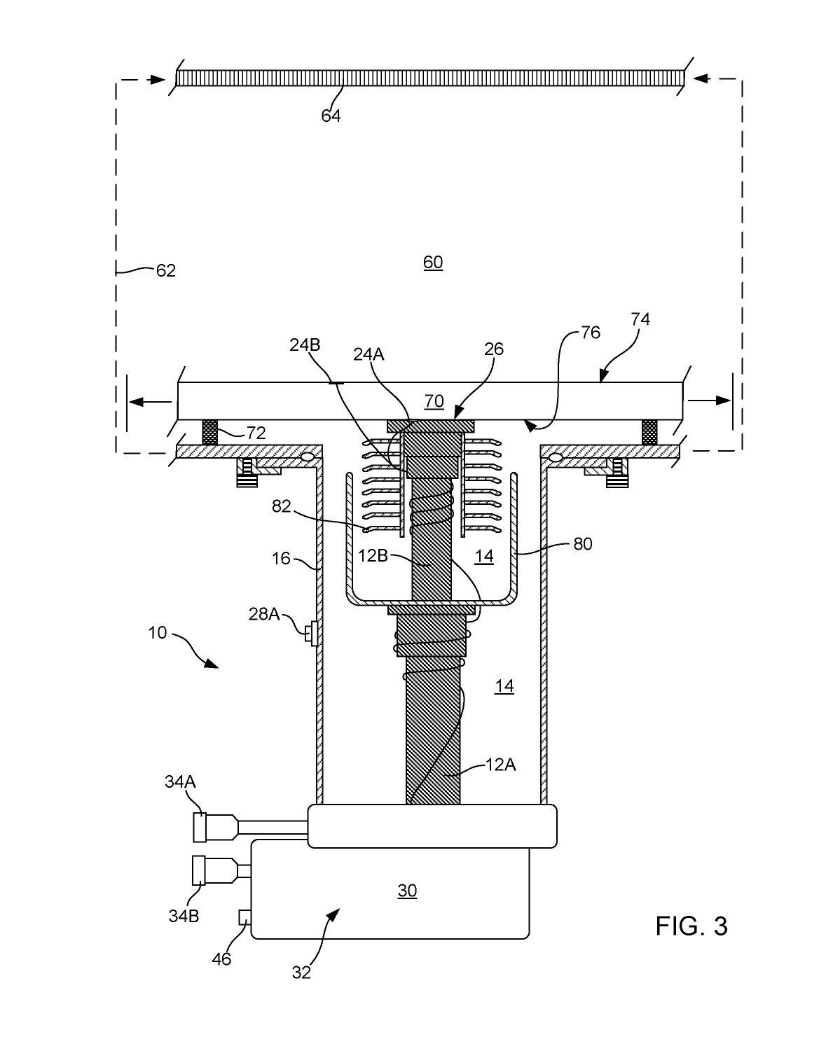

Regardless, whether using a single stage cold head assembly 12 providing temperature ranges from about 10 K to about 120 K, or a dual stage cold head assembly (not shown in FIGS. 1 and 2, but shown in FIG. 3) providing temperatures from about 4 K to about 120 K. temperatures can be sufficiently low to cryogenically treat a metal object at a temperature that is significantly lower than the temperature of liquid nitrogen, e.g., about 77 K. Furthermore, in certain general examples, the thermally conductive platform 70 and/or a working surface thereof, e.g., a top surface in the examples shown in FIGS. 1 and 2, can be configured to reach one or more temperature(s) from about 4 K to about 50 K at the vacuum pressure selected, e.g. up to about 100 mTorr. In another example, the thermally conductive platform and/or a working surface thereof can be configured to reach one or more temperature(s) from about 10 K to less than the boiling point of nitrogen, e.g., less than about 77 K. In another example, the thermally conductive platform and/or a working surface thereof, can be configured to reach one or more temperature(s) from about 10K to about 25 K at a vacuum pressure from about 10 mTorr to about 25 mTorr. In further detail regarding the thermally conductive platform, in addition to a working surface, which is an upper surface in this example, the thermally conductive platform can also include a connecting surface, which in this example is a lower surface of the thermally conductive surface. The cold head interface can be held in place and thermally coupled to the connecting surface, in one example, by a coupling assembly 18 that can be both attached to the cold head assembly 12 and the connecting surface (bottom surface in this example) of the thermally conductive platform.

In further detail regarding the thermally conductive platform, in certain examples, the working surface, e.g., upper surface in FIGS., and the connecting surface, e.g., lower surface in FIGS., can be opposing surfaces, as shown. However, the working surface and the connecting surface can alternatively be immediately adjacent surfaces, or even the same surface. That being described, the connecting surface in this example is the surface where the cold head interface 26 is thermally coupled to the thermally conductive platform. In still further detail, though the thermally conductive platform in the examples shown in the FIGS. has a plate-like configuration, the thermally conductive platform can be of any shape that acts to hold and cryogenically treat metal objects in accordance with the present disclosure. For example, the thermally conductive platform can have a box-shape, a curved (rounded, parabolic, etc.) shape, a specialized shape configured to match a predetermined metal object, etc. Thus, any shape suitable to provide appropriate contact between the thermally conductive platform, e.g., at a working surface, and a metal object to be treated can be used in accordance with the present disclosure. In certain of these configurations, the thermally conductive platform can have an average thickness from about ⅛ inch to about 2 inches, and in another example, the average thickness can be ¼ inch to about 1 inch, though these ranges are not intended to be particularly limiting.

In further detail regarding the thermally conductive platform 70, in order to achieve the very low temperature ranges described herein, the thermally conductive platform can be configured to only come in thermal contact with structures that contribute to its very low temperature, rather than increase its temperature. For example, the cold head interface 26 and a coupling assembly used to couple the thermally conductive platform to a connecting surface (of the thermally conductive platform) thereof can contact the thermally conductive platform. The coupling assembly 18 may include a flanged collar or similar connecting structure(s) and any hardware used to connect the cold head assembly 12 therewith. These structures, if thermally conductive, should not contact an outer cryogenic chamber wall 62 of the cryogenic treatment chamber 60 (or vacuum chamber), as such thermal contact can act to introduce unwanted heat to the thermally conductive platform. In further detail, particularly when the thermally conductive platform spans laterally from any support provided by the cold head interface and the coupling assembly, insulative standoffs 72 can be used to support the thermally conductive platform. This can be particularly useful when the thermally conductive platform is relatively thin, e.g., from about ⅛ inch to about 2 inches, from about ¼ inch to about 1 inch, etc., with a risk of the material bowing and touching a cryogenic chamber wall of the vacuum chamber. Thermally conductive platform material can be any material that is from very rigid to even somewhat flexible materials, particularly when thin, and can be, for example, aluminum, stainless steel, titanium, copper, or another solid metal or metal alloy material. The insulative standoffs can, for example, be positioned between the thermally conductive platform and a cryogenic chamber wall of the vacuum chamber. As the insulative standoffs are made of a thermally insulating material, such as a ceramic material, wood, certain plastics with low thermal conductivity, or fiberglass, for example, they do not introduce heat to the thermally conductive platform in an appreciable manner.

Regardless of whether a single stage or a dual stage expander assembly is used, the specific type of expanders can include any mechanical system that is suitable for expanding cryogenic fluids and generating cryogenic temperatures using pressurized cryogenic fluid 38A. Expander assemblies that can be used include motorized pistons that rapidly receive and expand the pressurized cryogenic fluid, thereby forming the expanded cryogenic fluid 38B. The expanded cryogenic fluid, in one example, can thus contact a distal-most end of the cold head assembly 12, also referred to herein as a cold head interface 26, which may be the coldest area of the cold head assembly generally. In a two stage cooling system, the expanded cryogenic fluid can be further expanded by a similar or different mechanism to reach even colder temperatures. Thus, as the cold head interface is cooled, the thermally conductive platform 70 can likewise be similarly cooled by thermal communication therewith. In further detail, the cold head assembly and insulative chamber 14 can be provided by or modified from a commercially available cryogenic water pump or other cryogenic high vacuum pump, such as the CTI Cryo-torr® water pumps or the CTI Cryo-torr® 4F, 8, 8F, 10, 100, 250F, 20HP, 400, or 500, all available from Helix Technology Corporation, for example. The Cryo-torr® water pump or high vacuum pumps can be, in one example, a single stage expander assembly such as shown in FIGS. 1 and 2, and in other examples, the Cryo-torr® high vacuum pumps can be dual stage expander assemblies such as shown in FIG. 3. Other cryogenic pump assemblies from other manufacturers can likewise be used with similar success. Notably, in the examples shown in FIGS. 1 and 2, the cryogenic chamber system does not further include any condensation control elements as is often included in these types of systems. At the operating pressures and temperatures described herein, in many examples, these types of cryogenic pumps or water pumps are not typically used as described herein, and thus, the need for condensation control elements or other specialty equipment may not be needed, e.g., filters, radiation shields, condensation arrays, inert gas purges, e.g., nitrogen, argon, or helium, gas line and/or chamber wall heating elements, chamber conditioning equipment, RF equipment, and/or metal deposit cycling equipment, etc. However, in other examples, condensation control elements such as those shown and described with respect to FIG. 3 can be present in any of the cryogenic chamber systems of the present disclosure.

Turning now to FIG. 3, a dual stage cryogenic chamber system is shown. This system is similar to that shown in FIGS. 1 and 2, but the expander assembly (not shown in FIG. 3, but shown schematically in FIG. 2 at 22) includes multiple displacers. For example, the expander assembly can include a first displacer that may be present and operable in a first stage cold head assembly 12A, and a second displacer that may be present and operable in a second stage cold head assembly 12B. In one example, the dual stage cold head assembly 12A, 12B can be a Gifford-McMahon type cryogenic cooler, or any other type of cold head assembly/cooling system known in the art which is suitable for expanding, and thus cooling cryogenic fluid. The first stage cold head assembly and the second stage cold head assembly can be operated by a motor 32 within a motor housing 30. As mentioned in the prior examples, the motor can operate a displacer in the expansion assembly, such as a reciprocating piston-type displacer. In this example, however, rather than operating a single displacer as described with respect to FIG. 2, the expander assembly can include multiple displacers for expanding the cryogenic fluid in a first expander region of the first stage cold head assembly, followed by additional expansion of the cryogenic fluid in a second expander region of the second stage cold head assembly. For example, a first displacer or piston can be provided in the first stage cold head assembly and can be configured to move reciprocally along or in a direction parallel with a central axis of the cylinder-shaped assembly, and a second displacer or piston can be provided in the second stage cold head assembly and can be configured to move reciprocally along or in parallel with a central axis of the cylinder-shaped assembly. Thus, in this example, the first displacer in the first cold head assembly and the second displacer in the second cold head assembly can be operationally connected together, driven by the motor, to work in concert to provide multiple cryogenic fluid expansions. As a note, the first stage cold head assembly and the second stage cold head assembly can collectively be referred to herein generally as a “cold head assembly,” and more specifically as a “dual stage cold head assembly.”

Also shown in FIG. 3 are additional system components that are not shown in FIGS. 1 and 2, but which could also be used in those examples. For example, a working surface temperature sensor 24A is shown which is thermally coupled to the thermally conductive platform 70 at a working surface thereof. Additionally, a cold head temperature sensor 24B is shown which is thermally coupled to the cold head interface 26 for determining the operational temperature of the cold head assembly generally. Thus, the temperature sensors can be used to determine when the working surface of the thermally conductive platform reaches an appropriate temperature for cryogenically treating metal objects, and that temperature information can be compared to the absolute coldest temperature that may be present at the cold head interface. In one example, there may be value in placing the working surface temperature sensor at a location that is distal to the cold head interface, e.g., within three inches of a periphery of the thermally conductive platform, to ensure that the areas that are furthest from the cold head interface are getting sufficiently cold to cryogenically treat metal objects of interest. Material choice, thickness, distance from the cold head interface, etc., can all play a factor in thermal conduction from the cold head interface to more distal locations along the thermally conductive platform.

In further detail, the insulative chamber 14 can also include any of a number of types of radiation shields, condensing arrays, or the like. In this specific example, the second stage cold head assembly 12A can be associated with a radiation shield 80, a condensing array 82, and/or other structures sometimes used in a cryogenic pump 10 generally. The radiation shield can be configured to protect the second stage cold head assembly in this example from radiant heat generated at the insulative chamber 14 under vacuum pressure, and can be cup-shaped with an upper part of the radiation shield in an open configuration. In some examples, there can be multiple radiation shields and/or multiple condensing arrays that perform different functions. For example, the condensing array may be an 80 K condensing array (not shown) which can condense water and hydrocarbon vapors. These types of condensing arrays are not typically needed in the cryogenic chamber systems of the present disclosure because in many examples, the vacuum pressures as low as 5 to 25 mTorr, for example, provide conditions where condensation is not particularly an issue. The condensing array may alternatively be a 15 K condensing array which can be useful for condensing nitrogen, oxygen, argon, etc. In some examples, when the array is a charcoal array, the array can trap helium, hydrogen, neon, etc. In further detail, though the radiation shield and the condensing array shown are associated with the second stage cold head assembly, these structures could be used on a single stage cold head assembly as shown in FIGS. 1 and 2, and/or at the first stage cold head assembly 12A of the present example.

Other structures shown in FIG. 3 are similar to those shown and described in relation to FIGS. 1 and 2. More specifically, the cryogenic chamber system can further include a cryogenic fluid supply port 34A and a cryogenic fluid return port 34B for receiving pressured cryogenic fluid from a compressor 36 and returning warmed cryogenic fluid to the compressor, respectively. The cryogenic pump 10 can be powered by connecting a power and/or control cable 48A to the power connection port 46. The insulative chamber 14 can be defined by a cryogenic pump vessel wall 16 with an open top that can be coupled to and sealed against cryogenic chamber walls 62 of a cryogenic treatment chamber 60. The thermally conductive platform 70 that is thermally coupled to the cold head interface 26 can be further supported by insulative standoffs 72, which can thermally insulate the thermally conductive platform and prevent the thermally conductive platform from contacting the cryogenic chamber wall, which would introduce unwanted heat into the cryogenic chamber system. Furthermore, a lid 64 is also shown that can be used to seal an object opening and introduce vacuum pressure to the vacuum chamber as a whole, which in this example is provided by the combined volume of the insulative chamber and the cryogenic treatment chamber. To introduce vacuum pressure, a vacuum pump (not shown in this FIG., but shown in FIG. 1) can be fluidly coupled to any of a number of auxiliary ports or valves, such as auxiliary port 28A, for example.

In any of the cryogenic chamber systems shown and described herein, it is notable that any type of control circuitry can be electrically associated with the electrically powered components. Control circuitry can be used, for example, to control timing, system coordination, vacuum pumps, cryogenic pumps, auxiliary valves, etc. Thus, in cryogenically treating a metal object, the temperature of the cold head interface 26 can be controlled modifying cryogenic fluid flow volumes, motor operation (which controls the expander assembly displacer(s)), operation times, vacuum pressures (using vacuum pumps and/or valves), etc. Thus, by cooling the cold head interface, the thermally coupled thermally conductive platform 70 can ultimately be controlled thermally within the cryogenic treatment chamber 60. Furthermore, as mentioned, by substantially voiding the vacuum chamber (collectively the cryogenic treatment chamber and the insulative chamber 14) of air at vacuum pressures less than 100 mTorr, or more particularly from about 5 mTorr to about 25 mTorr, very little condensation of water onto the surface of the various surfaces or metal objects within the vacuum chamber may result, thus, providing for an essentially dry cryogenic treatment system in accordance with the present disclosure. Thus, systems and methods described herein can exclude the use of condensation control elements often present within the vacuum chamber of cryogenic pumps. In other examples where there may be some condensation either from water or other cryogenic fluids or gases, any of a number of condensing arrays can be used within the vacuum chamber.

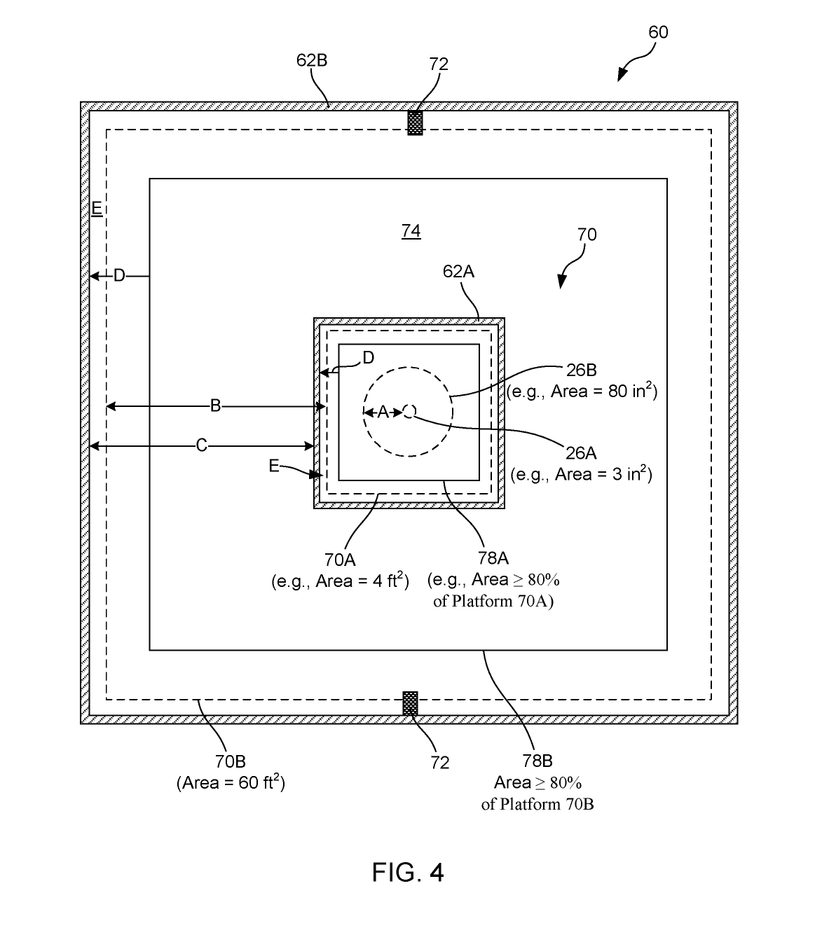

Turning now to FIG. 4, a schematic upper view of a cryogenic treatment chamber 60 is shown, including schematic details of various size ranges and size ratios for several structural features of the present disclosure. As a note, these ranges and ratios are provided by way of example only, and should not be considered limiting unless specifically required by an example of the present disclosure. As shown in this FIG., a first cold head interface 26A can have a surface area of 3 square inches (in²) and a second cold head interface 26B can have a surface area of 80 square inches (in²). Thus, in this specific example, a range of sizes (A) of cold head interfaces from about 3 square inches to about 80 square inches can also be used. In another example, the cold head interface can have a surface area from about 3 in² to about 120 in², from about 6 in² to about 80 in², from about 12 in² to about 50 in², or from about 25 in² to about 120 in². As mentioned, the ranges shown in FIG. 4 are by example only, and other size ranges can thus be implemented. The cold head interface areas shown in this example are also shown generally as circular in shape, but could be any functional shape that is usable. In further detail, the cold head interface can be defined herein to include only the area directly associated with expanded and cooled cryogenic fluid contained therebeneath (see FIG. 2 at 26, for example), and does not include coupling assembly components that may be used to couple the cold head assembly generally to the thermally conductive platform. As can also be seen in this particular example, cold head interface can be thermally coupled to a connecting surface (not shown but beneath and opposite the upper visible working surface) at a central region of the thermally conductive platform.

The thermally conductive platform 70 can be formed from a material and of a configuration so that a periphery of the thermally conductive platform (shown in phantom lines ranging in size from 70A to 70B, for example) can reach substantially the same or similar low temperature (within 50% of the temperature K) as the central region of the thermally conductive platform. For example, in one embodiment, the entire working surface can be brought to within 50%, 25%, 10%, or even 5% of a temperature K of the cold head interface 26A, 26B. For example, if the cold head interface is brought to 10 K, then the entire working surface may be no higher than 15 K (based on 50%), or no higher than 12.5 K (based on 25%), in these specific examples. Or, if the cold head interface is brought to 50 K, then the entire working surface may be no higher than 75 K (based on 50%), or no higher than 55 K (based on 5%), for example. In some more specific examples, the thermally conductive platform can have a working surface that is at least 20 times larger than a surface area of the cold head interface, and the entire working surface can be brought to within 25% of a temperature K of the cold head interface. In another example, the thermally conductive platform can have a working surface that is at least 40 times larger than a surface area of the cold head interface, and the entire working surface can be brought to within 25% of a temperature K of the cold head interface. In another example, the thermally conductive platform can have a working surface that is at least 60 times larger than a surface area of the cold head interface, and the entire working surface can be brought to within 50% of a temperature K of the cold head interface. Other combinations of size relationships and working surface temperatures can also be achieved, e.g., at least 20 times larger with up to 5% temperature difference, at least 40 times larger with up to 10% temperature difference, at least 60 times larger with up to 25% temperature difference, at least 50 times larger with up to 50% temperature difference, at least 100 times larger with up to 25% temperature difference, at least 100 times larger with up to 50% temperature difference, etc., depending on the materials chosen, the cold head interface temperature achieved, the thermally conductive platform thickness, etc. As an example, a 4 square foot aluminum or copper thermally conductive platform with a relatively small cold head interface, e.g., about 3 to about 8 square inches, can reach temperatures at a periphery within about 2 K of the cold head interface temperature. This can translate to metal objects being cryogenically treated reaching temperatures within about 10 K, or even within about 5 K, of the cold head interface in some examples.

Also as shown in FIG. 4, a first thermally conductive platform 70A can have a working surface area of 4 square feet (ft²), and a second thermally conductive platform 70B can have a working surface area of 60 square feet (ft²). Thus, in this specific example, a range of area sizes (B) of the thermally conductive platform can be from about 4 square feet to about 60 square feet. However, in another example, the thermally conductive platform can alternatively have a working surface area from about 1.5 ft² to about 100 ft², from about 2.25 ft² to about 60 ft², from about 4 ft² to about 40 ft², from about 6 ft² to about 36 ft², or from about 8 ft² to about 32 ft². As mentioned, the ranges shown in FIG. 4 are by example only, and other size ranges can thus be implemented. In further detail, cryogenic chamber wall 62A (small) or cryogenic chamber wall 62B (large) can represent an example range area sizes (C) for the cryogenic chamber and are generally large enough to accommodate whatever size thermally conductive platform that may be present therein. Space (E) is shown representing the space between the cryogenic chamber wall and the periphery of the thermally conductive platform. This space is shown as minimal, e.g., from about ½ inch to about 6 inches, but can be smaller or even much larger, and furthermore, may (as shown) or may not (not shown) match the general shape of the thermally conductive platform. In either case, with examples of the present disclosure, the cryogenic chamber wall should not touch the thermally conductive platform as such contact can introduce heat into the cryogenic chamber system. In accordance with this, insulative standoffs 72 can be used to support the thermally conductive platform and to separate the thermally conductive platform from the cryogenic chamber wall, either therebeneath as shown in FIGS. 1-3, or along a periphery as shown in FIG. 4. When the thermally conductive standoffs are used at a periphery of the cryogenic chamber between the thermally conductive platform and the cryogenic chamber wall, in one example, the insulative standoffs can be notched and pressure fit between an edge of the thermally conductive platform and the cryogenic chamber wall.

In additional detail, the cryogenic treatment chamber 60 can also include an object opening, which is shown at 78A and 78B. In this example, the size relationship range (D) of the object opening relates to the size of the thermally conductive platform size. Thus, in one example, when the thermally conductive platform has a working surface area as shown at 70A (which in this example is the upper surface where the metal objects are placed), the object opening can be at least 80% in area size compared to the area size of the working surface. Thus, size relationship (D) can represent an area that is from about 80% to greater than about 100% the size of the working surface of the thermally conductive platform, e.g., from about 80% to about 150%, from about 80% to about 120%, from about 80% to about 100%, from about 90% to about 150%, from about 90% to about 120%, from about 90% to about 100%, from about 100% to about 150%, from about greater than about 100% to about 150%, etc.

Another size relationship that can be considered is the ratio in area size between the working surface of the thermally conductive platform (ranging from size 70A to 70B, by way of example) and the cold head interface (ranging in size from 26A to 26B, by way of example). In one example, the working surface can have a surface area that is at least 10 times larger than a surface area of the cold head interface, e.g., 10:1 by area, or at least 20 times larger than a surface area of the cold head interface, e.g., 20:1 by area. In another example, the working surface can have a surface area that is at least 40 times larger than a surface area of the cold head interface, e.g., 40:1 by area. In another example, the working surface can have a surface area that is at least 60 times larger than a surface area of the cold head interface, e.g., 60:1 by area. In another example, the working surface can have a surface area that is at least 100 times larger than a surface area of the cold head interface, e.g., 100:1 by area.

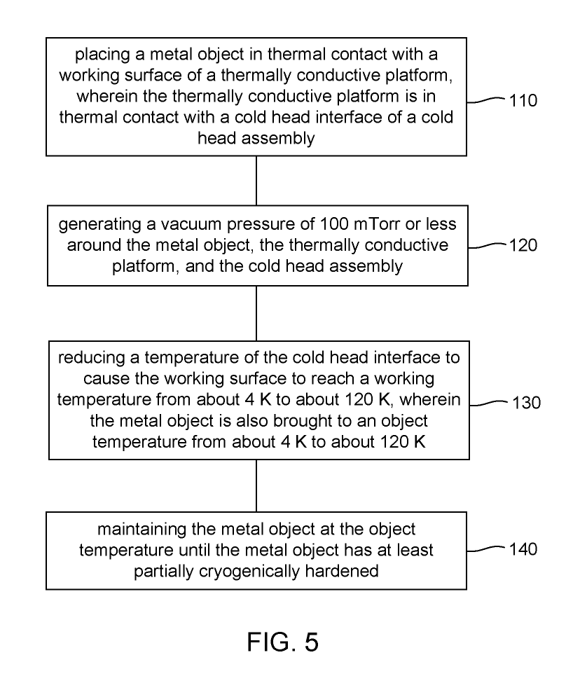

Turning now to FIG. 5, a flow chart of a method of cryogenically treating metal objects is shown, and can include placing 110 a metal object in thermal contact with a working surface of a thermally conductive platform such that the thermally conductive platform is in thermal contact with a cold head interface of a cold head assembly. The method can also include generating 120 a vacuum pressure of 100 mTorr or less around the metal object, the thermally conductive platform, and the cold head assembly. An additional step can include reducing 130 a temperature of the cold head interface to cause the working surface to reach a working temperature from about 4 K to about 120 K, wherein the metal object is brought to an object temperature from about 4 K to about 120 K. The method can also include maintaining the metal object at the object temperature until the metal object has at least partially cryogenically hardened, e.g., 15 minutes to 36 hours, 30 minutes to 18 hours, 1 hour to 10 hours, 1 hour to 6 hours, etc. In one example, after maintaining, the metal object can be warmed back to room temperature slowly, e.g., from about 15 minutes to about 12 hours, from about 30 minutes to about 8 hours, from about 1 hour to about 4 hours, or at any other suitable time frame to minimize stress on the metal object after it has been at least partially cryogenically hardened. Since the process described herein can be an essentially dry process, unlike hardening with liquid nitrogen, warming back to room temperature can be conducted in a more controlled manner by controlling the warming rate within the cryogenic vacuum chamber. For example, cryogenic cooling temperatures from the cold head assembly can be gradually increased, ambient temperatures around the cryogenic vacuum chamber can be used to raise the temperature within the vacuum chamber, heating elements can be used, refrigeration systems (other than that provided by the cold head assembly) can be used, etc.

In one example, at the vacuum pressure and working temperature, substantially no liquid condensation is formed on the metal object without the presence of any condensation control elements. In another example, the thermally conductive platform can have a working surface area that is at least 10 times larger than a surface area of the cold head interface. In another example, the working surface area can be at least 10 times larger, at least 20 times larger, at least 40 times larger, at least 60 times larger, etc., than a surface area of the cold head interface. In yet another example, the vacuum pressure can be from about 5 mTorr to about 50 mTorr, from about 5 mTorr to about 25 mTorr, from about 10 mTorr to about 20 mTorr, etc. In still another example, method can include an additional step of supporting the thermally conductive platform with insulative standoffs. In further detail, the vacuum chamber can include an object opening for inserting the metal objects therethrough onto the working surface of the thermally conductive platform, and in one example, the object opening can be at least 80% in area size as a surface area of the working surface. In another example, the object opening can be about the same size or larger than the surface area of the working surface.

It is noted that, as used in this specification and the appended claims, the singular forms “a,” “an,” and “the” include plural referents unless the content clearly dictates otherwise.

The term “about” as used herein, when referring to a numerical value or range, allows for a degree of variability in the value or range, for example, within 5% or other reasonable added range breadth of a stated value or of a stated limit of a range. The term “about” when modifying a numerical range is also understood to include the exact numerical value indicated, e.g., the range of about 1 inch to about 10 inches includes 1 inch to 10 inches, as well as the explicitly recited exact values of 1 inch and 10 inches as an explicitly supported sub-range or numeric value in every instance where the term “about” modifies a numerical range or specific value.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list based on their presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, as well as to include all the individual numerical values or sub-ranges encompassed within that range as if each numerical value and sub-range is explicitly recited. For example, a size range of about 1 inch to about 10 inches should be interpreted to include the explicitly recited limits of 1 inch and 10 inches, the subrange of 1 inch to 10 inches, and further may include individual sizes therebetween, such as about 1 inch to 5 inches, 5 inch to 10 inches, 2 inches to 9 inches, etc.

While the present technology has been described with reference to certain examples, those skilled in the art will appreciate that various modifications, changes, omissions, and substitutions can be made without departing from the disclosure. It is intended, therefore, that the disclosure be limited only by the scope of the following claims.

What is claimed is:

1. A cryogenic chamber system, comprising:
a vacuum chamber operable at a vacuum pressure of 100 mTorr or less;
a cold head assembly including an expander assembly for receiving and expanding cryogenic fluid for cooling a cold head interface, wherein the cold head assembly is positioned within the vacuum chamber;
a thermally conductive platform thermally coupled to the cold head interface within the vacuum chamber, wherein the thermally conductive platform has a working surface having a surface area that is at least 10 times larger than a surface area of the cold head interface, and wherein the working surface is configured to reach a temperature from about 4 K to about 120 K at the vacuum pressure as a result of thermal coupling with the cold head interface.

2. The cryogenic chamber system of claim 1, further comprising a vacuum pump fluidly coupled to the vacuum chamber to generate the vacuum pressure.

3. The cryogenic chamber system of claim 1, wherein the vacuum pressure is from about 5 mTorr to about 25 mTorr within the vacuum chamber.

4. The cryogenic chamber system of claim 1, wherein the vacuum chamber comprises two chambers coupled together with a coupling seal, the two chambers including an insulative chamber about the cold head assembly and a cryogenic treatment chamber which contains the thermally conductive platform.

5. The cryogenic chamber system of claim 1, wherein the expander assembly includes one or more linearly actuated displacer, and is either a single stage expander assembly a dual stage expander assembly.

6. The cryogenic chamber system of claim 1, wherein the cryogenic fluid is helium-3, helium-4, hydrogen, neon, nitrogen, air, fluorine, argon, oxygen, methane, or a mixture thereof.

7. The cryogenic chamber system of claim 1, wherein the working surface is configured to reach one or more temperature from about 4 K to about 50 K at the vacuum pressure across the entire working surface.

8. The cryogenic chamber system of claim 1, wherein no thermally conductive structure that would introduce heat to the thermally conductive platform is in contact therewith.

9. The cryogenic chamber system of claim 1, wherein the thermally conductive platform is further supported by insulative standoffs in addition to the cold head assembly.

10. The cryogenic chamber system of claim 9, wherein insulative standoffs are ceramic.

11. The cryogenic chamber system of claim 1, wherein the cold head interface is thermally coupled to a connecting surface of the thermally conductive platform at a central region of the thermally conductive platform, and wherein the thermally conductive platform is of a material and configuration that a periphery of the entire working surface is brought to within 50% of a temperature K of the cold head interface.

12. The cryogenic chamber system of claim 1, wherein the cold head interface has a surface are from about 3 in² to about 120 in².

13. The cryogenic chamber system of claim 1, wherein the working surface has a surface area from about 1.5 ft² to about 100 ft².

14. The cryogenic chamber system of claim 1, wherein the vacuum chamber includes an object opening for inserting metal objects on the working surface of the thermally conductive platform that is at least 80% in area size as the surface area of the working surface.

15. The cryogenic chamber system of claim 1, wherein the working surface has a surface area that is at least 20 times larger than a surface area of the cold head interface.

16. The cryogenic chamber system of claim 1, wherein the working surface has a surface area that is at least 40 times larger than a surface area of the cold head interface.

17. The cryogenic chamber system of claim 1, wherein the thermally conductive platform has an average thickness from about ⅛ inch to about 2 inches.

18. The cryogenic chamber system of claim 1, wherein the vacuum chamber does not further include any condensation control elements therein.

19. A method of cryogenically treating metal objects, comprising:
placing a metal object in thermal contact with a working surface of a thermally conductive platform, wherein the thermally conductive platform is in thermal contact with a cold head interface of a cold head assembly;
generating a vacuum pressure of 100 mTorr or less around the metal object, the thermally conductive platform, and the cold head assembly;
reducing a temperature of the cold head interface to cause the working surface to reach a working temperature from about 4 K to about 120 K, wherein the metal object is also brought to an object temperature from about 4 K to about 120 K; and
maintaining the metal object at the object temperature until the metal object has at least partially cryogenically hardened.

20. The method of claim 19, wherein at the vacuum pressure and working temperature, substantially no liquid condensation is formed on the metal object without the presence of any condensation control elements.

21. The method of claim 19, wherein the thermally conductive platform has a working surface that is at least 20 times larger than a surface area of the cold head interface.

22. The method of claim 19, wherein the vacuum pressure is from about 5 mTorr to about 25 mTorr.

23. The method of claim 19, further comprising supporting the thermally conductive platform with insulative standoffs.

24. The method of claim 19, wherein the vacuum chamber includes an object opening for inserting the metal objects therethrough onto the working surface of the thermally conductive platform, wherein the object opening is at least 80% in area size as a surface area of the working surface.

25. The method of claim 19, wherein the entire working surface is brought to within 50% of a temperature K of the cold head interface along the entire working surface.

26. The method of claim 19, where the step of maintaining is for 15 minutes to 36 hours.
